(19) United States
(12) Patent Application Publication
(10) Pub. No.: US 2019/0063299 A1
(43) Pub. Date: Feb. 28, 2019

(54) EXHAUST SYSTEM FOR VEHICLE

(71) Applicant: MAZDA MOTOR CORPORATION, Hiroshima (JP)

(72) Inventors: Keishi KITABATAKE, Hiroshima-shi (JP); Taku KURAMASHI, Hatsukaichi-shi (JP); Tamotsu TAKAMURE, Hiroshima-shi (JP)

(73) Assignee: MAZDA MOTOR CORPORATION, Hiroshima (JP)

(21) Appl. No.: 16/103,676

(22) Filed: Aug. 14, 2018

(30) Foreign Application Priority Data
Aug. 24, 2017 (JP) 2017-161496

(51) Int. Cl. F01N 13/10; F02M 26/15; F02M 26/22; F01N 3/28; F02B 75/20

(52) U.S. Cl. CPC F01N 13/10; F02M 26/15; F02B 2075/1816; F01N 3/28; F02B 75/20; F02M 26/22

(57) ABSTRACT

In order to improve the performance of keeping the temperature of an exhaust purifier when a vehicle is running, an engine is provided with an exhaust passage behind a cylinder head in the vehicle longitudinal direction. The exhaust passage includes an exhaust manifold and an exhaust purification system disposed serially in a flow direction of an exhaust gas, the exhaust manifold being located upstream of the exhaust purification system. The exhaust purification system contains a GPF device configured to purify a gas. The exhaust purification system is located below the exhaust manifold, and is disposed so as to overlap the exhaust manifold in the vehicle transverse direction. The exhaust purification system is also disposed so as to protrude with respect to the exhaust manifold rearward in the vehicle longitudinal direction.

### CROSS-REFERENCE TO RELATED APPLICATION

This application claims priority to Japanese Patent Application No. 2017-161496 filed on Aug. 24, 2017, the entire disclosure of which is incorporated by reference herein.

### BACKGROUND

The technology disclosed herein relates to exhaust systems for vehicles.

Japanese Unexamined Patent Publication No. 2017-89562 discloses an example exhaust system for a vehicle. Specifically, Japanese Unexamined Patent Publication No. 2017-89562 describes an engine (internal combustion engine) including a cylinder head, an exhaust manifold coupled to the cylinder head, and an exhaust purifier (e.g., a catalyst case) that is disposed downstream of the exhaust manifold in the gas flow direction. The exhaust purifier described in Japanese Unexamined Patent Publication No. 2017-89562 is configured such that it extends generally downward, so that the exhaust purifier is hidden by the exhaust manifold as viewed from above the vehicle.

Incidentally, the exhaust purifier as described in Japanese Unexamined Patent Publication No. 2017-89562 above is typically equipped with a purifier having the capability to purify a gas. In particular, if the purifier is a catalyst, the catalyst temperature may be adjusted into a predetermined active temperature range within which the catalyst satisfactorily performs purification, by an exhaust gas introduced into the exhaust purification system.

However, for example, in an engine that can undergo both spark ignited combustion and compression ignition combustion, and in which the gas temperature therefore fluctuates relatively greatly (i.e., the fluctuation width is great), it is likely to be difficult to adjust the catalyst temperature into the above range.

In particular, in a situation that the gas temperature is relatively low (e.g., the engine is running at a light load), the catalyst temperature is likely to be lower than the lower limit of the active temperature. In order to provide sufficient purification performance, a mechanism to improve the performance of keeping the temperature of the catalyst may be provided.

The above problem is common to components of the purifier such as a filter member formed of an inorganic porous material, in addition to the catalyst.

### SUMMARY

With the above problem in mind, the technology disclosed herein has been made. The present disclosure describes an exhaust system for a vehicle that includes an exhaust purifier having improved temperature keeping performance which is exhibited when the vehicle is running

The technology disclosed herein features an exhaust system for a vehicle.

An exhaust system for a vehicle includes an exhaust passage and an engine cover. The exhaust passage is coupled to a side surface of an engine. The exhaust passage includes an exhaust manifold and an exhaust purifier disposed serially in a flow direction of an exhaust gas, the exhaust manifold being located upstream of the exhaust purifier. The exhaust purifier is located below the exhaust manifold, and is disposed so as to overlap the exhaust manifold in a vehicle transverse direction. At least a part of the exhaust purifier protrudes with respect to the exhaust manifold rearward in a vehicle longitudinal direction. The engine cover is configured to cover the engine and provided above the engine to define a gap between the engine cover and the engine in which natural air is allowed to pass, the engine cover having a rear end inclined toward the exhaust manifold.

When the vehicle is running forward, natural air is introduced into the engine room, flowing from the front to the rear in the vehicle longitudinal direction. At least a portion of the natural air flows over the engine, and then flows diagonally downward and rearward along a side surface of the engine.

Here, the exhaust manifold is coupled to one side surface of the engine. Therefore, a portion of the natural air flowing as described above cools the exhaust manifold, and proportionately receives heat from the exhaust manifold.

With the above feature, the exhaust purifier is located below the exhaust manifold, and protrudes rearward with respect to the exhaust manifold. Since the exhaust manifold overlaps the exhaust purifier in the vehicle transverse direction, the exhaust purifier is located diagonally below and behind the exhaust manifold.

Therefore, the natural air that has flown along a side portion of the engine diagonally downward and rearward, has cooled the exhaust manifold, and has proportionately received heat from the exhaust manifold, flows over an external surface of the exhaust purifier in the flow direction. The natural air flowing over the external surface of the exhaust purifier can keep the temperature of the exhaust purifier, and the temperature of a purifier contained in the exhaust purifier.

Thus, the performance of keeping the temperature of the exhaust purifier can be improved when the vehicle is running.

Furthermore, since the rear end of the engine cover is inclined toward the exhaust manifold, natural air can be reliably introduced to the exhaust manifold when the vehicle is running at low speed, in which case it is assumed that the flow speed or flow rate of the natural air is relatively low. This is effective in ensuring the performance of keeping the temperature of the purifier.

Meanwhile, when the vehicle is running at high speed, in which case it is assumed that the natural air has a sufficient flow rate, etc., and the exhaust gas has an excessively high gas temperature, a large amount of natural air is advantageously guided to the exhaust manifold. This allows the exhaust manifold to be cooled, and further, allows an exhaust gas passed through the exhaust manifold and then introduced into the exhaust purification system to be cooled. This inhibits, for example, the occurrence of a situation that the catalyst temperature exceeds the upper limit of the active temperature, and therefore, is effective in ensuring the performance of keeping the temperature of the purifier, such as a catalyst.

Thus, the performance of keeping the temperature of the purifier is advantageously ensured from low vehicle speed to high vehicle speed.

In addition, the exhaust purifier may have an upstream end disposed below the exhaust manifold, and a downstream end disposed behind the exhaust manifold.

With this feature, the upstream end of the exhaust purifier is disposed below the exhaust manifold. Such a disposition allows the upstream end of the exhaust purifier to be closer to the exhaust manifold than the downstream end thereof is. As a result, the temperature of an upstream portion of the exhaust purifier can be kept by utilizing the heat of radiation from the exhaust manifold.

Meanwhile, the downstream end of the exhaust purifier is disposed behind the exhaust manifold. As described above, such a disposition allows the temperature of a downstream portion of the exhaust purifier to be kept by utilizing the natural air.

Thus, by keeping the temperature of the entirety (from the upstream end to the downstream end) of the exhaust purifier, the performance of keeping the temperature of the purifier is advantageously ensured.

In addition, the exhaust system may further include a partition wall configured to separate a rear of an engine room in the vehicle longitudinal direction and including a conduit extending from the partition wall rearward in the vehicle longitudinal direction. The engine may be configured to be mounted in the engine room. The exhaust purifier may be disposed so as to coincide with the conduit as viewed from in front of or behind the vehicle.

A conduit portion may be provided in a dash panel so as to separate a space for accommodating an exhaust duct directly coupled to a muffler or a drive shaft linked to rear wheels of an FR automobile. Natural air flows from the engine room into the conduit portion.

With the above feature, the conduit portion coincides with the exhaust purifier as viewed from in front of or behind the vehicle. Such a layout allows the exhaust purifier to be positioned in the flow path of natural air, and therefore, the natural air is advantageously blown to the exhaust purifier.

In addition, the exhaust purifier may include a purifier contained in the part and configured to purify an exhaust gas, and the purifier is configured to function as a gasoline particulate filter. The exhaust system may further include an EGR passage coupled to the exhaust passage downstream of the purifier and configured to cause at least a portion of a combusted gas to flow back into an air intake passage of the engine.

With this feature, a combusted gas that has been passed through the purifier can be used as an external EGR gas. In this case, the flow rate of the gas passing through the purifier can be increased compared to the configuration in which the EGR passage is coupled upstream of the purifier, for example. Therefore, the temperature of the purifier is advantageously kept by the gas passing therethrough.

Furthermore, the purifier functions as a gasoline particulate filter (GPF). Therefore, a combusted gas from which soot has been removed by the GPF can be used as an external EGR gas. This can inhibit or reduce the accumulation of deposits contained in the external EGR gas in the air intake passage coupled to the EGR passage.

In addition, the exhaust purifier may include a purifier contained in the part and configured to purify an exhaust gas. The exhaust manifold may have branch passages coupled to respective cylinders of the engine, and a merging structure in which the branch passages merge together, and is coupled to the exhaust purifier. The exhaust system may further include an EGR cooler configured to cool a combusted gas and disposed on one side of the purifier in the vehicle transverse direction and in front of the purifier in the vehicle longitudinal direction, and the merging structure is disposed on another side of the purifier in the vehicle transverse direction and in front of the purifier in the vehicle longitudinal direction.

The EGR cooler cools a combusted gas, and proportionately receives heat from the combusted gas. Therefore, the EGR cooler that has received heat can be used as a heat source.

As described above, natural air is introduced into the engine room of the vehicle, flowing from the front to the rear in the vehicle longitudinal direction. At least a portion of the introduced natural air flows from the cylinder head diagonally downward and rearward. Meanwhile, the other portion of the natural air flows rearward from one side and the other side in the vehicle transverse direction of the engine, moving around the engine.

With the above feature, the EGR cooler, which can be used as a heat source as described above, is disposed on one side in the vehicle transverse direction, and in front in the vehicle longitudinal direction, of the purifier. Therefore, the natural air that flows from one side in the vehicle transverse direction of the engine, moving around the engine, receives heat from the EGR cooler before reaching the exhaust purifier. The resultant natural air can keep the temperature of the purifier provided in the exhaust purifier.

Meanwhile, the merging structure of the exhaust manifold is disposed on the other side in the vehicle transverse direction, and in front in the vehicle longitudinal direction, of the purifier. Therefore, the natural air that flows from the other side in the vehicle transverse direction of the engine, moving around the engine, receives heat from the merging structure of the exhaust manifold before reaching the external surface of the exhaust purifier. The resultant natural air can keep the temperature of the purifier provided in the exhaust purifier.

Thus, not only the natural air flowing from the cylinder head diagonally downward and rearward, but also the natural air flowing rearward from one side and the other side in the vehicle transverse direction of the engine, moving around the engine, are advantageously used to enhance the performance of keeping the temperature of the purifier.

As described above, the above exhaust system for a vehicle can enhance the performance of keeping the temperature of the exhaust purifier.

### BRIEF DESCRIPTION OF THE DRAWINGS

FIG. 1 is a diagram schematically showing a vehicle including a powertrain.

FIG. 2 is a diagram showing a powertrain as viewed behind.

FIG. 3 is a vertical cross-sectional view showing a configuration of an exhaust passage.

FIG. 4 is a perspective view showing an entire configuration of an exhaust passage.

FIG. 5 is a diagram showing an exhaust passage as viewed from behind.

FIG. 6 is a diagram showing an exhaust passage as viewed from above.

FIG. 7 is a diagram showing an exhaust purification system as viewed from above.

FIG. 8 is a cross-sectional view showing an internal structure of an exhaust purification system.

FIG. 9 is a diagram showing an external EGR system as viewed from the left.

FIG. 10 is a diagram showing an external EGR system as viewed from above.

FIG. 11 is a diagram showing a relative positional relationship between an exhaust purification system and a conduit portion.

### DETAILED DESCRIPTION

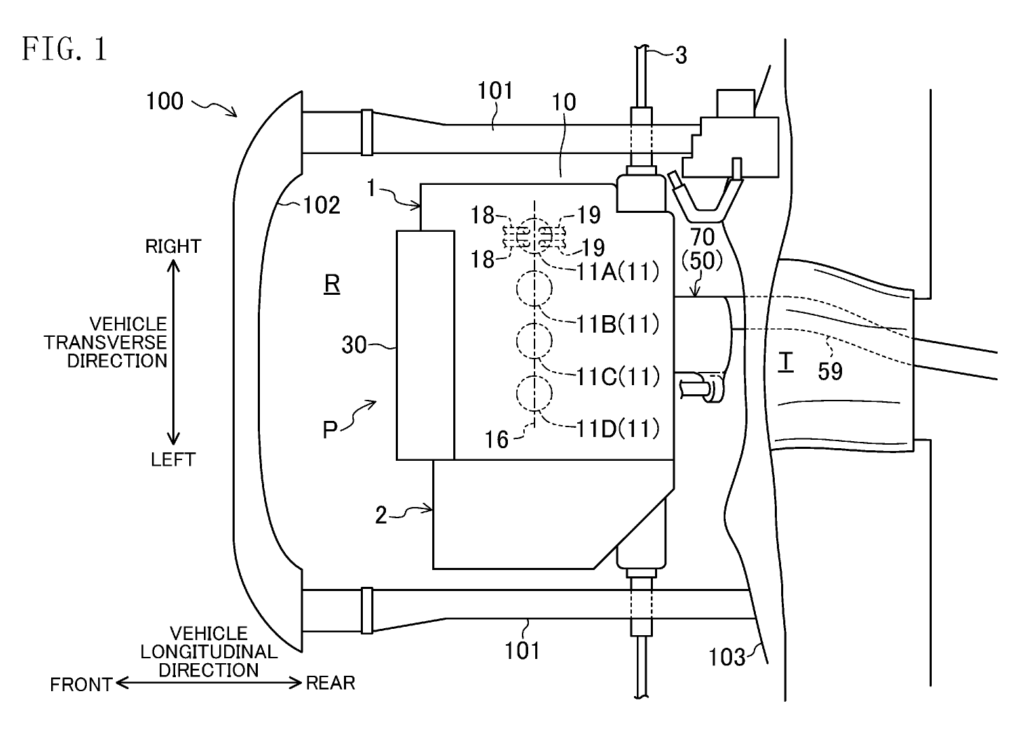

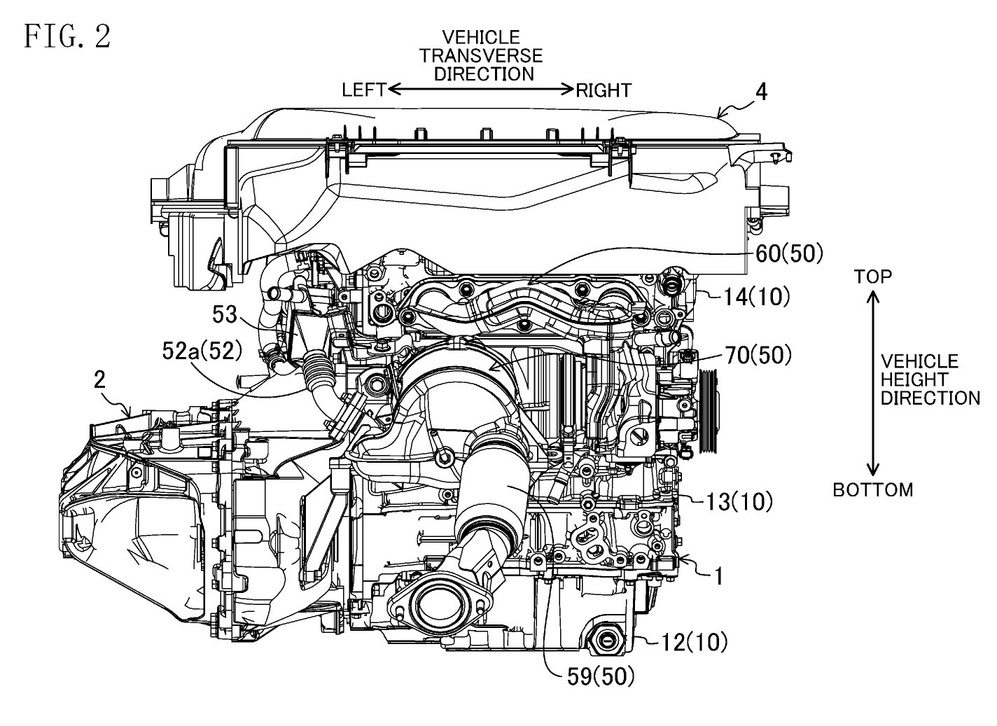

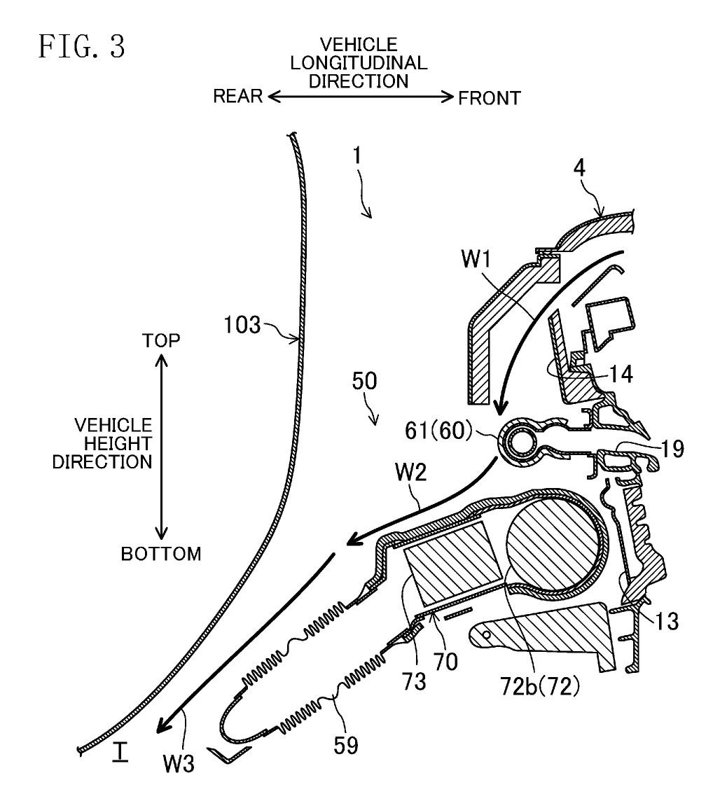

Embodiments of an exhaust system for a vehicle will now be described in detail with reference to the accompanying drawings. Note that the descriptions below are only for illustrative purposes. FIG. 1 is a diagram showing a front portion of an automobile (vehicle) 100 including a powertrain P to which an exhaust system for a vehicle disclosed herein is applied. FIG. 2 is a diagram showing the powertrain P as viewed behind. FIG. 3 is a vertical cross-sectional view showing a configuration of an exhaust passage 50.

(Overview of Configuration of Powertrain)

Firstly, a configuration of the powertrain P will be outlined.

The powertrain P includes an engine 1 and a transmission 2 linked to the engine 1. The engine 1 is, for example, a four-stroke gasoline engine that is configured such that it can undergo both spark ignited combustion and compression ignition combustion. Meanwhile, the transmission 2, which is, for example, a manual transmission, transfers the output of the engine 1 to a drive shaft 3, which is then driven to rotate.

The automobile 100 equipped with the powertrain P is a front-engine, front-wheel-drive four-wheel car. Specifically, the powertrain P, the drive shaft 3, and drive wheels (i.e., the front wheels) linked to the drive shaft 3, are all disposed in a front portion of the automobile 100.

The vehicle body of the automobile 100 includes a plurality of frames. In particular, a front vehicle body includes a pair of left and right side frames 101 that are provided on opposite sides in the vehicle transverse direction, extending in the longitudinal direction of the automobile 100, and a front frame 102 that is supported by the pair of side frames 101, spanning between front ends of the side frames 101.

The front portion of the vehicle body is partitioned to provide an engine room R, in which the powertrain P is mounted. The engine room R is formed by a bonnet (not shown) that is disposed above the powertrain P, and becomes higher from front to rear, and a dash panel 103 that is disposed behind the engine 1, and separates the engine room R from a cabin that accommodates passengers, as shown in FIG. 1. Note that the dash panel 103 is disposed behind the engine 1, and separates a rear portion of the engine room R, and in this sense, is illustrated as a “partition wall.” The partition wall is not limited to the dash panel 103, and may be formed by at least one of a plurality of members such as a cowling (not shown) located above the dash panel 103, and a floor panel (not shown).

As shown in FIG. 1, a conduit portion T that extends from the dash panel 103 rearward in the vehicle longitudinal direction is provided at a middle portion in the vehicle transverse direction of the dash panel 103. In the conduit portion T, a duct for guiding an exhaust gas to a muffler is disposed, and natural air flows out of the engine room R when the vehicle is running

The engine 1 includes four cylinders 11 arranged in a line. The four cylinders 11 are arranged side by side in the vehicle transverse direction, i.e., the engine 11 is the so-called inline four-cylinder transverse engine. Therefore, in this embodiment, the engine longitudinal direction in which the four cylinders 11 are arranged (cylinder array direction) is substantially the same as the vehicle transverse direction, and the engine transverse direction is substantially the same as the vehicle longitudinal direction.

Note that, in an inline multi-cylinder engine, the cylinder array direction is the same as the central axis direction (engine output axis direction) of a crankshaft 16 as an engine output axis. In the description that follows, these directions are all referred to as a “cylinder array direction (or vehicle transverse direction).”

Unless otherwise specified, the terms “front,” “forward,” “in front of,” etc., refers to one of two opposite directions, sides, or positions in the engine transverse direction (i.e., the front in the vehicle longitudinal direction), the terms “rear,” “rearward,” “behind,” etc., refers to the other in the engine transverse direction (i.e., the rear in the vehicle longitudinal direction), the terms “left,” “leftward,” etc., refers to one of two opposite directions, sides, or positions in the engine longitudinal direction (cylinder array direction) (i.e., the left in the vehicle transverse direction, the rear of the engine, and the side of the powertrain P on which the transmission 2 is located), and the terms “right,” “rightward,” etc., refers to the other in the engine longitudinal direction (cylinder array direction) (i.e., the right in the vehicle transverse direction, the front of the engine, and the side of the powertrain P on which the engine 1 is located).

In the description that follows, the terms “upper,” “upward,” “top,” etc., refers to one of two opposite directions, sides, or positions in the vehicle height direction that is above the powertrain P when the powertrain P is mounted in the automobile 100 (also hereinafter referred to as a “mounted-in-vehicle state”), and the terms “lower,” “downward,” “bottom,” etc., refers to the other in the vehicle height direction below the powertrain P in the mounted-in-vehicle state.

Meanwhile, the transmission 2 is attached to a left side surface of the engine 1, and is adjacent to the engine 1 in the cylinder array direction. As shown in FIG. 2, a dimension in the height direction of the transmission 2 is shorter than that of the engine 1.

An engine cover 4 for covering the engine 1 is provided above the engine 1 (specifically, above a cylinder head 14). A gap in which natural air is allowed to pass is formed between the engine 1 and the engine cover 4. As shown in FIG. 3, a rear end of the engine cover 4 is inclined or oriented diagonally downward and rearward so that natural air flowing along a lower surface of the rear end is guided to the exhaust passage 50 (specifically, the exhaust manifold 60).

(Overview of Configuration of Engine)

Next, a configuration of the engine 1 included in the powertrain P will be outlined.

In this example configuration, the engine 1 of the front intake/rear exhaust type. Specifically, the engine 1 includes an engine body 10 having four cylinders 11, an air intake passage 30 that is disposed in front of the engine body 10, and is in communication with each cylinder 11 through air intake ports 18, and an exhaust passage 50 that is disposed behind the engine body 10, and is in communication with each cylinder 11 through exhaust ports 19.

The air intake passage 30 allows a gas (fresh air) introduced from the outside to be passed therethrough so that the gas is supplied to each cylinder 11 of the engine body 10. In this example configuration, the air intake passage 30 forms, in front of the engine body 10, an air intake system that is a combination of a plurality of passages for introducing a gas and devices such as a supercharger and an intercooler.

The engine body 10 is configured such that the combustion of an air-fuel mixture of a gas supplied from the air intake passage 30 and a fuel occurs in each cylinder 11. Specifically, the engine body 10 has an oil pan 12, a cylinder block 13 attached on the oil pan 12, and a cylinder head 14 placed on the cylinder block 13, in that order with the oil pan 12 being the lowest one of them. Power obtained from the combustion of an air-fuel mixture is output through the crankshaft 16 provided in the cylinder block 13.

The above four cylinders 11 are formed in the cylinder block 13. The four cylinders 11 are arranged side by side in the central axis direction of the crankshaft 16 (i.e., the cylinder array direction). The four cylinders 11 are each in the shape of a cylinder. Each cylinder 11 has a center axis (hereinafter referred to as a “cylinder axis”). The center axes of the four cylinders 11 are parallel to each other and perpendicular to the cylinder array direction. The four cylinders 11 shown in FIG. 1 may hereinafter be referred to as the “first cylinder 11A,” “second cylinder 11B,” “third cylinder 11C,” and “fourth cylinder 11D,” respectively, in that order in the cylinder array direction with the first cylinder 11A being the rightmost one of them.

In the cylinder head 14, two air intake ports 18 are formed for each cylinder 11 (shown only for the first cylinder 11A). The two air intake ports 18 are arranged adjacent to each other in the cylinder array direction, and are each in communication with the corresponding cylinder 11.

In the cylinder head 14, two exhaust ports 19 are formed for each cylinder 11. The two exhaust ports 19 are in communication with the corresponding cylinder 11.

The exhaust passage 50 is a passage through which an exhaust gas emitted from the engine body 10 due to the combustion of an air-fuel mixture flows. Specifically, the exhaust passage 50 is disposed behind the engine body 10, and is in communication with the exhaust ports 19 of each cylinder 11. In the exhaust passage 50, an exhaust manifold 60 and an exhaust purification system 70 are arranged in that order in the direction that an exhaust gas flows, with the exhaust manifold 60 being located upstream of the exhaust purification system 70. The exhaust purification system 70 contains a gasoline particulate filter (GPF) device 73 that functions as a gasoline particulate filter. Note that the exhaust purification system 70 is an example “exhaust purifier,” and the GPF device 73 is an example “purifier.”

In this example configuration, the exhaust passage 50 forms an exhaust system that is a combination of a plurality of passages for guiding a gas such as the exhaust manifold 60, and devices such as the exhaust purification system 70.

Referring back to FIG. 1, the air intake passage 30 and the exhaust passage 50 are coupled to a front surface and rear surface (an external surface 14a described below), respectively, of the engine body 10. An EGR passage 52 that couples the air intake passage 30 and the exhaust passage 50 together to form an external EGR system is provided outside the engine body 10 (to the left of the engine body 10 in FIG. 2). The EGR passage 52 is for causing a portion of a combusted gas to flow back into the air intake passage 30. An upstream end of the EGR passage 52 is coupled to a portion of the exhaust passage 50 that is located downstream of the GPF device 73. A downstream end of the EGR passage 52 is coupled to a portion of the air intake passage 30 that is located downstream of a throttle valve (not shown).

A water-cooling EGR cooler 53 is provided in the EGR passage 52. The EGR cooler 53 is configured to cool a combusted gas. The EGR cooler 53 cools an external EGR gas, and proportionately receives heat from the external EGR gas. Therefore, the EGR cooler 53 that has received heat can be used as a heat source.

(Configuration of Exhaust Passage)

Next, a configuration of the exhaust passage 50 of the engine 1 will be described in detail.

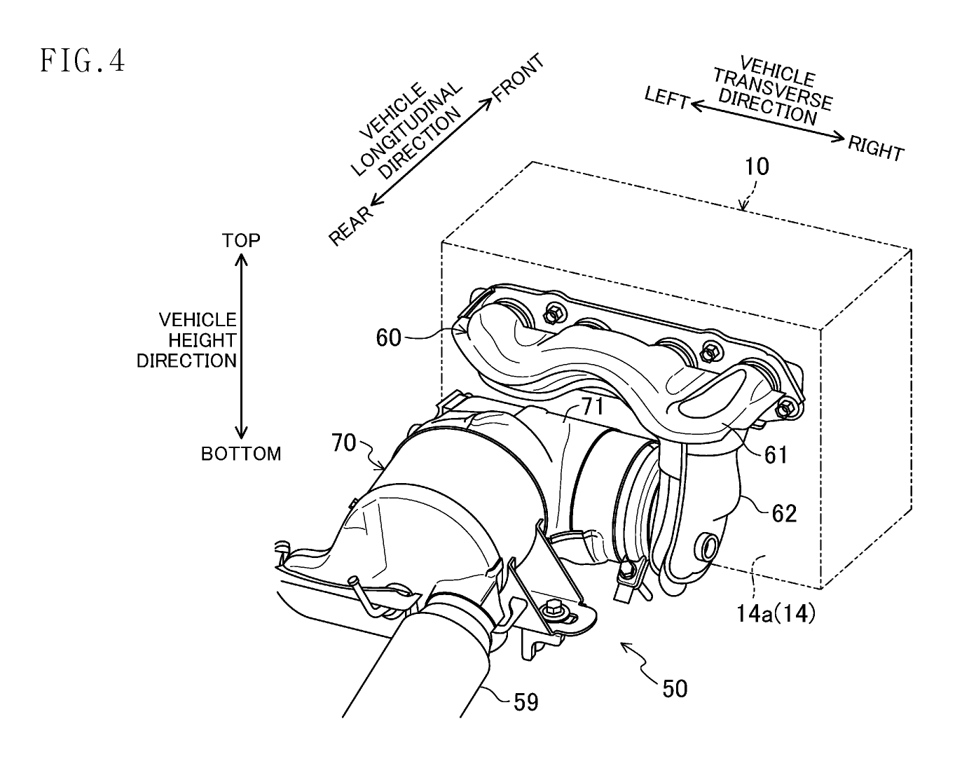

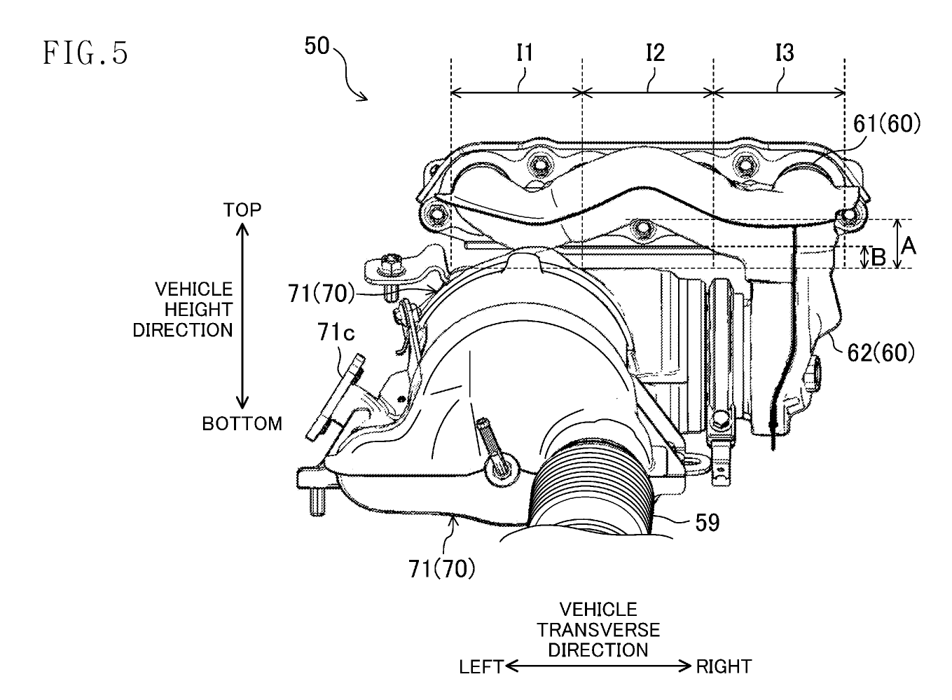

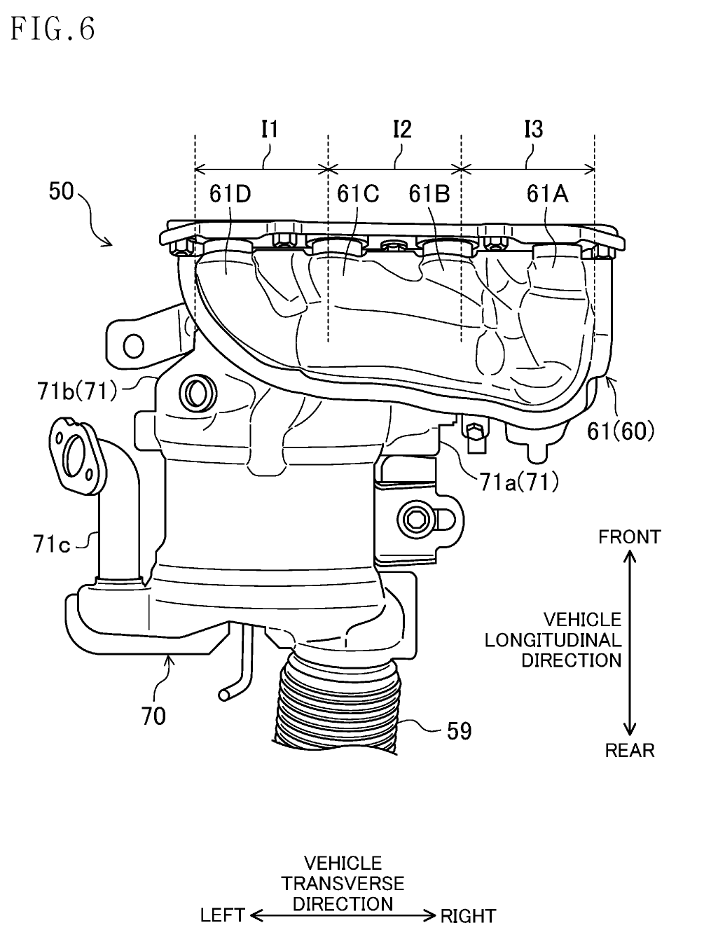

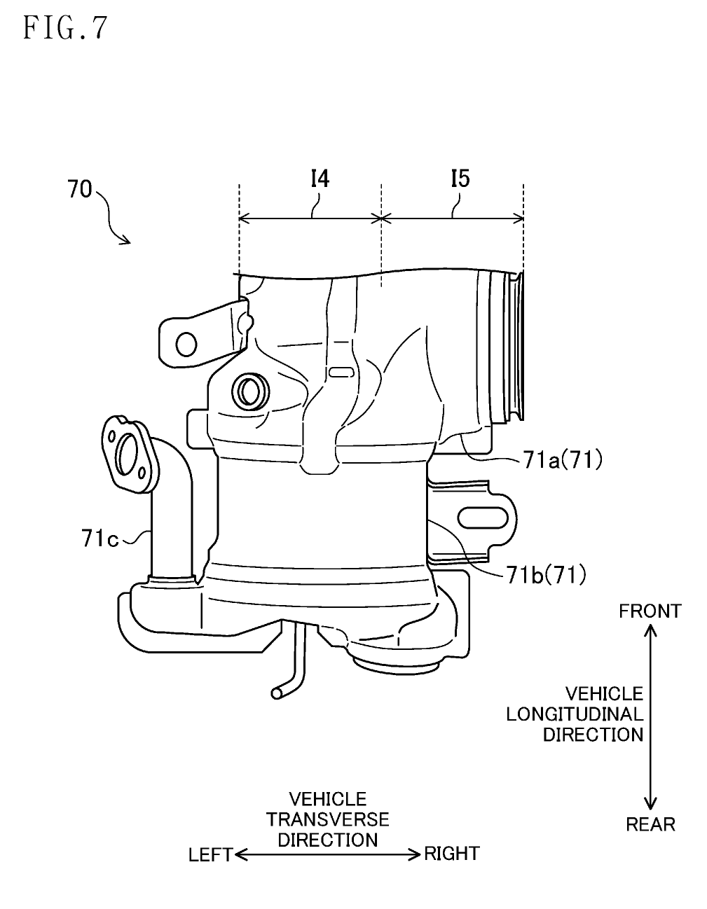

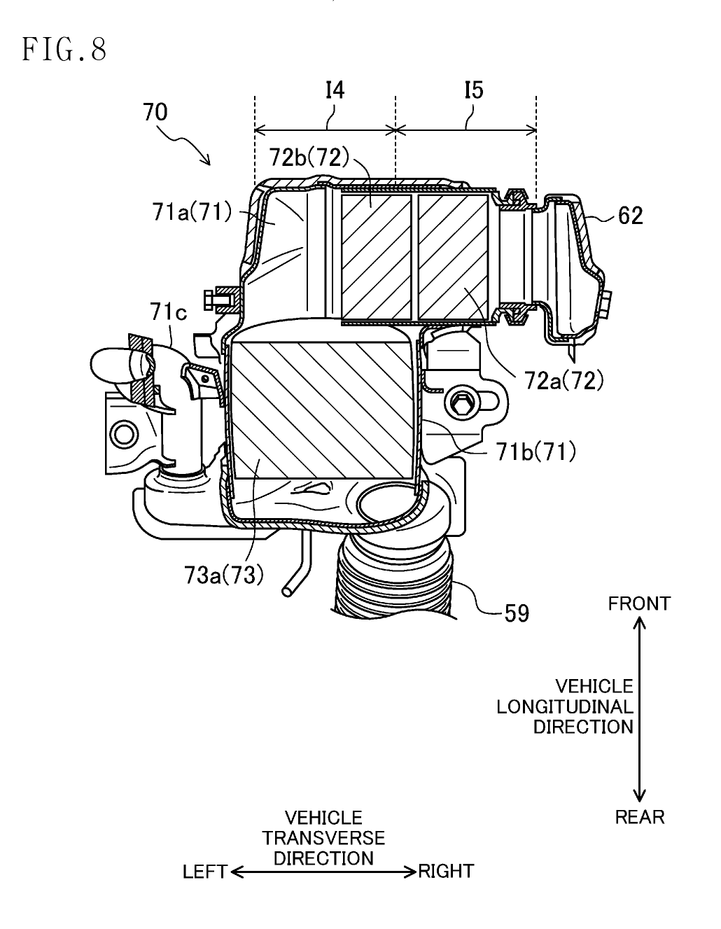

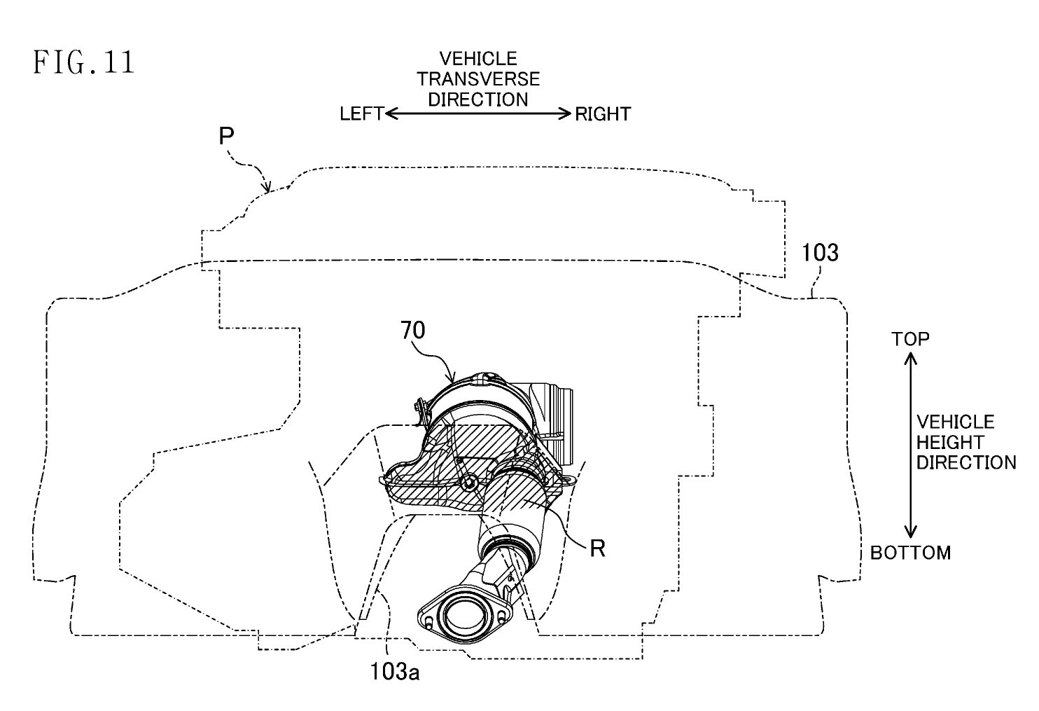

FIG. 4 is a perspective view showing an entire configuration of the exhaust passage 50. FIG. 5 is a diagram of the exhaust passage 50 as viewed from behind. FIG. 6 is a diagram showing the exhaust passage 50 as viewed from above. FIG. 7 is a diagram showing the exhaust purification system 70 as viewed from above. FIG. 8 is a cross-sectional view showing an internal structure of the exhaust purification system 70. FIG. 11 is a diagram showing a relative positional relationship between the exhaust purification system 70 and the conduit portion T.

The components of the exhaust passage 50 are all coupled to the engine body 10, particularly a rear external surface 14a of the cylinder head 14. As described above, the exhaust passage 50 is configured by a combination of the exhaust manifold 60 and the exhaust purification system 70.

Firstly, a configuration of the exhaust manifold 60 will be described.

As shown in FIG. 3, the exhaust manifold 60 is disposed below an upper end of the cylinder head 14. As shown in FIG. 4, the exhaust manifold 60 is configured as a duct that has branch passages 61 coupled to the respective cylinders 11 of the engine 1, and a merging structure 62 in which the branch passages 61 merge together.

The branch passage 61 has an outer shape that is substantially W-shaped as viewed from behind. Specifically, the branch passage 61 has three portions in the cylinder array direction, i.e., a curved portion that protrudes downward (see a section I1), a curved portion that protrudes upward (see a section I2), and a curved portion that protrudes downward again (see a section I3), in that order from left to right (see FIG. 5).

The branch passage 61 also has a first branch passage 61A coupled to the first cylinder 11A, a second branch passage 61B coupled to the second cylinder 11B, a third branch passage 61C coupled to the third cylinder 11C, and a fourth branch passage 61D coupled to the fourth cylinder 11D.

As shown in FIG. 6, the first branch passage 61A extends substantially forward from the external surface 14a of the cylinder head 14 as viewed from above. The second to fourth branch passages 61B to 61D all extend diagonally forward right from the external surface 14a of the cylinder head 14 as viewed from above, and merge with the first branch passage 61A.

The merging structure 62 is disposed at substantially the same position as that of the first cylinder 11A in the cylinder array direction, extending downward from a downstream end (rear end) of the first branch passage 61A. Specifically, an upstream end (upper end) of the merging structure 62 is coupled to a downstream end of the branch passage 61. A downstream end (lower end) of the merging structure 62 is open leftward. An upstream end of a casing 71 included in the exhaust purification system 70 is coupled to the downstream end (lower end) of the merging structure 62.

Next, a configuration of the exhaust purification system 70 will be described.

Here, the exhaust purification system 70 will be described in terms of a relative positional relationship with the powertrain P, or the vehicle body of the automobile 100. The exhaust purification system 70 is disposed immediately behind the cylinder block 13, and is located at substantially the middle of the engine 1 in the vertical direction, and is slightly displaced from the middle to the left in the vehicle transverse direction. As can be seen from a region R shown in FIG. 11, the exhaust purification system 70 is disposed so as to coincide with the conduit portion T of the dash panel 103 as viewed from behind the vehicle.

A relative positional relationship between the exhaust purification system 70 and the exhaust manifold 60 will be described. The exhaust purification system 70 is located below the exhaust manifold 60 (specifically, the branch passage 61 of the exhaust manifold 60), and overlaps the exhaust manifold 60 (the branch passage 61) in the vehicle transverse direction. The exhaust purification system 70 (specifically, a vertical side portion 71b described below) is disposed and oriented so as to protrude with respect to the exhaust manifold 60 (the branch passage 61) rearward in the vehicle longitudinal direction.

Specifically, the exhaust purification system 70 includes the substantially L-shaped casing 71, and a catalyst converter 72 and the GPF device 73, which are contained in the casing 71.

As shown in FIG. 7, the casing 71 is a substantially L-shaped pipe that has a horizontal side extending in the vehicle transverse direction, and a vertical side extending toward the rear of the automobile 100 (particularly, the front and rear of the letter L are reversed in the vehicle longitudinal direction).

A right end of a portion of the casing 71 corresponding to the horizontal side of the letter L (hereinafter referred to as a “horizontal side portion” and indicted by a reference character “71a”) is open to the right. This right end is an upstream end of the casing 71, i.e., an upstream end of the entire exhaust purification system 70, and is directly coupled to the downstream end of the merging structure 62 as described above. The horizontal side portion 71a including the right end (i.e., the upstream end) of the casing 71 is disposed immediately below the exhaust manifold 60 (specifically, the branch passage 61). Meanwhile, a left end of the horizontal side portion 71a is linked to a front end of a portion of the casing 71 corresponding to the vertical side of the letter L (hereinafter referred to as a “vertical side portion” and indicated by a reference character “71b”).

As can be seen from FIGS. 5-8, the horizontal side portion 71a has two portions in the cylinder array direction. The downstream one of the two portions that is located on the left (see a section I4) is located directly below a curved portion (see the section I1) of the branch passage 61 that protrudes downward.

Meanwhile, the upstream one of the two portions of the horizontal side portion 71a in the cylinder array direction, that is located on the right (see a section I5), is located directly below a curved portion (see the section I2) of the branch passage 61 that protrudes upward.

In other words, the portions of the branch passage 61 corresponding to the sections I1 and I2 overlap the portions of the horizontal side portion 71a corresponding to the sections I4 and I5 in the cylinder array direction.

Meanwhile, as shown in FIGS. 4, 6, and 7, the vertical side portion 71b of the casing 71 protrudes toward the rear of the automobile 100. A rear end of the vertical side portion 71b is a downstream end of the casing 71, i.e., a downstream end of the entire exhaust purification system 70, is disposed behind the exhaust manifold 60, and is open toward the rear. This opening portion is coupled to an upstream end of an exhaust duct 59. The exhaust duct 59 is extended out from the interior of the engine room R through the above conduit portion T, and is coupled to a muffler (not shown) in the rear of the automobile 100.

A discharge portion 71c for discharging a combusted gas out of the casing 71 is provided near a rear end of the vertical side portion 71b, and is coupled to the upstream end of the EGR passage 52. As can be seen from FIG. 8, the discharge portion 71c is provided downstream of the GPF device 73. As a result, the upstream end of the EGR passage 52 is coupled to a portion of the exhaust passage 50 that is located downstream of the GPF device 73 as described above.

As can be seen from FIG. 11, the vertical side portion 71b of the casing 71 coincides with the conduit portion T of the dash panel 103.

As shown in FIG. 8, the catalyst converter 72 is of a two-bed type in which two (upstream and downstream) honeycomb catalysts 72a and 72b are arranged in series and are contained in a catalyst container. The upstream honeycomb catalyst 72a is a honeycomb support that supports a first catalyst. The downstream honeycomb catalyst 72b is a honeycomb support that supports a second catalyst.

The first catalyst is active in an oxidation reaction of an unsaturated high hydrocarbon, such as toluene, at a low temperature compared to the second catalyst. Meanwhile, the second catalyst is active in an oxidation reaction of an unsaturated low hydrocarbon, such as isopentane, at a low temperature compared to the first catalyst.

The two honeycomb catalysts 72a and 72b, which are both formed in the shape of substantially a short tube, are contained in an upstream portion (see the section I5) on the right side of the horizontal side portion 71a of the casing 71. Therefore, the two honeycomb catalysts 72a and 72b are located directly below a curved portion (see the section I2) of the branch passage 61 that protrudes upward. The portion of the branch passage 61 corresponding to the section I2 protrudes upward, and therefore, is proportionately separated upward from the two honeycomb catalysts 72a and 72b.

Note that the downstream portion (see the section I4) on the left side of the horizontal side portion 71a is a cavity. Therefore, this cavity portion is located directly below a curved portion (see the section I1) of the branch passage 61 that protrudes downward. The portion of the branch passage 61 corresponding to the section I1 protrudes downward, and therefore, proportionately sinks downward and is closer to the cavity portion.

The GPF device 73 is a filter container containing a catalyst filter 73a. The catalyst filter 73a is a ceramic filter body formed of an inorganic porous material that supports the second catalyst. Although not shown, the catalyst filter 73a has a honeycomb structure including a large number of cells extending in parallel to each other.

The GPF device 73, which is in the shape of substantially a cylinder, is contained in the vertical side portion 71b of the casing 71. Taking into account the relative positional relationship between the vertical side portion 71b and the exhaust manifold 60, the GPF device 73 is located behind the branch passage 61 and the merging structure 62. The vertical side portion 71b, which is formed in the shape of substantially a tube, is an example “tube-shape.” The vertical side portion 71b as the tube-shape is disposed to protrude rearward. The GPF device 73 as the purifier is contained in the vertical side portion 71b.

(Configuration of External EGR System)

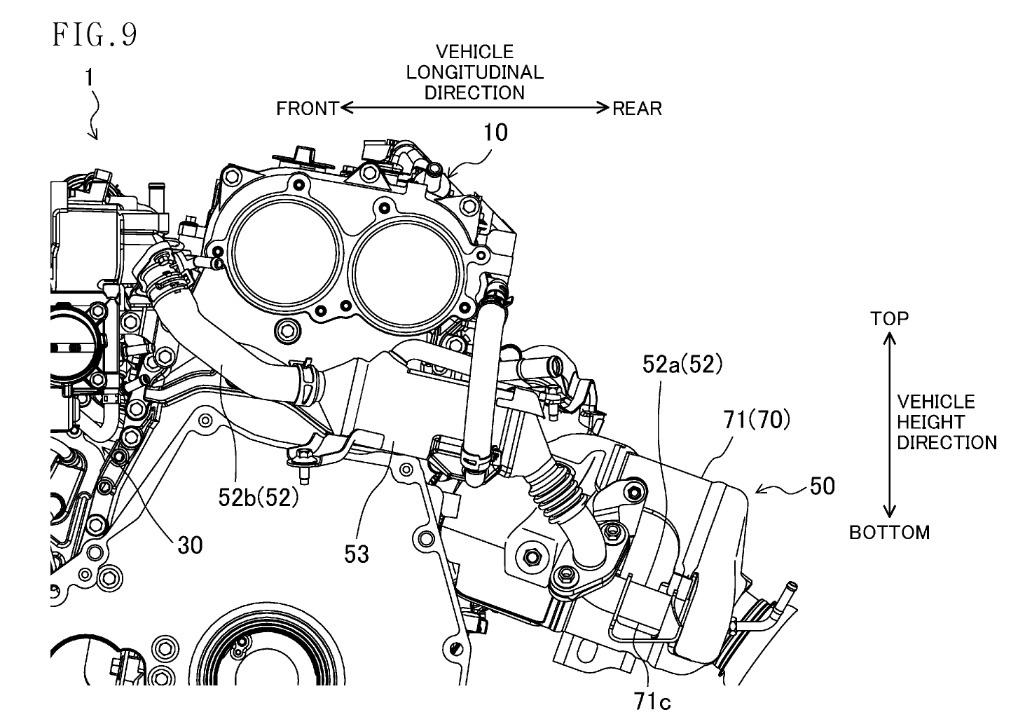

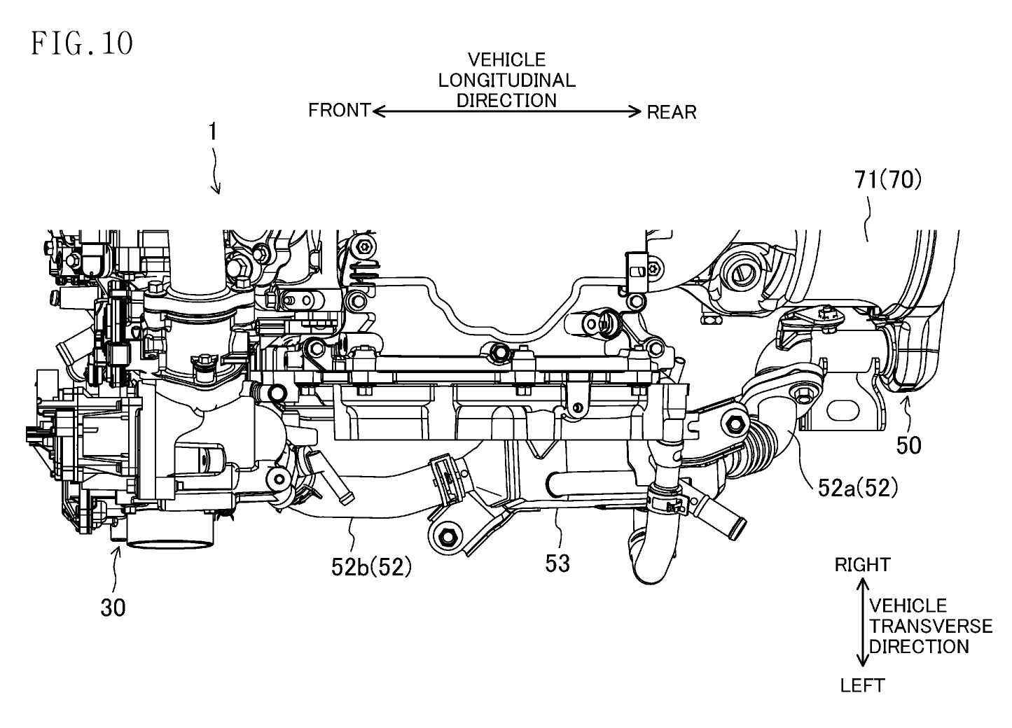

FIG. 9 is a diagram showing the external EGR system as viewed from the left. FIG. 10 is a diagram showing the external EGR system as viewed from above. Note that FIGS. 9 and 10 do not show the transmission 2.

As shown in FIG. 9, the EGR passage 52 branches from the exhaust passage 50 including the exhaust purification system 70, and a downstream end of the EGR passage 52 is coupled to the air intake passage 30. Specifically, the EGR passage 52 branches from a portion of the exhaust passage 50 that is located downstream of the exhaust purification system 70, and is coupled to the air intake passage 30.

As described above, the EGR passage 52 includes the EGR cooler 53 for cooling a gas passing in the EGR passage 52. A portion of the EGR passage 52 in which the exhaust passage 50 and the EGR cooler 53 are coupled together is hereinafter referred to as an “upstream EGR passage 52a.” A portion of the EGR passage 52 in which the EGR cooler 53 and the air intake passage 30 are coupled together is hereinafter referred to as a downstream EGR passage 52b.

Specifically, as shown in FIGS. 9 and 10, the upstream EGR passage 52a extends diagonally upward and forward along a left side portion of the exhaust passage 50, and then, turns to the left without interfering with a left side portion of the engine body 10. Thereafter, the upstream EGR passage 52a extends diagonally upward and forward again, to reach the EGR cooler 53. As described above, the upstream end of the upstream EGR passage 52a is coupled to the discharge portion 71c of the exhaust purification system 70 in the exhaust passage 50. Meanwhile, a downstream end (front end) of the upstream EGR passage 52a is coupled to an upstream end (rear end) of the EGR cooler 53.

The EGR cooler 53 is formed in the shape of a rectangular tube that is slightly diagonally inclined with respect to the longitudinal direction. In at least the mounted-in-vehicle state, the EGR cooler 53 is disposed at substantially the same position as that of the exhaust manifold 60 in the vertical direction (i.e., above the exhaust purification system 70), with openings at opposite ends of the EGR cooler 53 facing diagonally in the longitudinal direction. The upstream end of the EGR cooler 53 faces diagonally downward and rearward, and as described above, is coupled to the downstream end of the upstream EGR passage 52a. Meanwhile, a downstream end (front end) of the EGR cooler 53 faces diagonally upward and forward, and is coupled to an upstream end (rear end) of the downstream EGR passage 52b.

The downstream EGR passage 52b extends upward as one progresses downstream in the gas flow direction. Specifically, as shown in FIGS. 9 and 10, the downstream EGR passage 52b is configured to extend diagonally upward and forward along the left side portion of the engine body 10, and then, turn substantially to the front. As described above, the upstream end (rear end) of the downstream EGR passage 52b is coupled to the downstream end of the EGR cooler 53. Meanwhile, a downstream end (front end) of the downstream EGR passage 52b is coupled to a rear portion of the air intake passage 30.

(Configurations Related to Running of Automobile)

The powertrain P includes a powertrain control module (PCM) for operating the powertrain P. The PCM determines a state of the operation of the engine 1, and calculates control amounts of various actuators, according to detection signals output from various sensors. Thereafter, an ECU outputs control signals corresponding to the calculated control amounts to the actuators, and thereby operates the engine 1.

The output of the engine 1 is transferred to the drive shaft 3 through the transmission 2. This causes wheels linked to the drive shaft 3 to rotate, which allows the automobile 100 to run.

When the automobile 100 is running forward, natural air is introduced into the engine room R, flowing from the front to the rear in the vehicle longitudinal direction. At least a portion of the introduced natural air flows over the cylinder head 14 as indicated by an arrow W1 shown in FIG. 3, and then flows diagonally downward and rearward along a rear portion of the cylinder head 14.

Incidentally, in order to cause the GPF device 73 to perform sufficient purification performance, the catalyst temperature may be adjusted into a predetermined active temperature range by an exhaust gas introduced into the exhaust purification system 70.

However, in this example configuration in which the engine 1 is configured such that it can undergo both spark ignited combustion and compression ignition combustion, the gas temperature fluctuates relatively greatly (i.e., the fluctuation width is great). In the engine 1 having such a feature, it is likely to be difficult to adjust the catalyst temperature into the above range.

In particular, in a situation that the gas temperature is relatively low (e.g., the engine is running at a light load), the catalyst temperature is likely to be lower than the lower limit of the active temperature. In order to provide sufficient purification performance, a mechanism to improve the performance of keeping the temperature of the GPF device 73 may be provided.

The engine 1 of this embodiment is configured, taking into account natural air that is introduced into the automobile 100 when the automobile 100 is running, and the layout of the exhaust manifold 60 and the exhaust purification system 70.

Specifically, as shown in FIG. 3, the exhaust manifold 60 is coupled to a rear portion of the cylinder head 14. As described above, this allows natural air flowing along the arrow W1 to cool the exhaust manifold 60, and proportionately receive heat from the exhaust manifold 60.

As shown in FIG. 4, etc., the exhaust purification system 70 is located below the exhaust manifold 60, and the exhaust purification system 70 protrudes rearward with respect to the exhaust manifold 60. Since the exhaust manifold 60 overlaps the exhaust purification system 70 in the vehicle transverse direction, the exhaust purification system 70 is located diagonally below and behind the exhaust manifold 60.

Therefore, the natural air that has cooled the exhaust manifold 60 and thereby received heat from the exhaust manifold 60 flows over an external surface of the exhaust purification system 70 as indicted by an arrow W2 shown in FIG. 3. The natural air flowing over the external surface of the exhaust purification system 70 can keep the temperatures of the exhaust purification system 70 and the GPF device 73 contained in the exhaust purification system 70.

Thus, when the vehicle is running, the performance of keeping the temperature of the exhaust purification system 70 can be enhanced.

As shown in FIG. 3, the rear end of the engine cover 4, which is located above the cylinder head 14, is inclined or oriented diagonally downward and rearward (specifically, toward the exhaust manifold 60). Therefore, the natural air flowing over the engine cover 4 can be guided to the exhaust manifold 60.

In particular, when the vehicle is running at low speed, in which case it is assumed that the flow speed or flow rate of the natural air is relatively reduced, the natural air can be more reliably guided to the exhaust manifold 60. This is effective in ensuring the performance of keeping the temperature of the GPF device 73.

Meanwhile, when the vehicle is running at high speed, in which case it is assumed that the natural air has a sufficient flow rate, etc., and the exhaust gas has an excessively high gas temperature, a large amount of natural air is advantageously guided to the exhaust manifold 60. This allows the exhaust manifold 60 to be cooled, and further, allows an exhaust gas passed through the exhaust manifold 60 and then introduced into the exhaust purification system 70 to be cooled. This inhibits the occurrence of a situation that the catalyst temperature exceeds the upper limit of the active temperature, and therefore, is effective in ensuring the performance of keeping the temperature of the GPF device 73.

Thus, the performance of keeping the temperature of the GPF device 73 is advantageously ensured over the range from low vehicle speed to high vehicle speed.

As shown in FIGS. 4-6, the upstream end of the exhaust purification system 70 is disposed below the exhaust manifold 60. This allows the upstream end of the exhaust purification system 70 to be closer to the exhaust manifold 60 than the downstream end thereof is. As a result, the temperature of an upstream portion of the exhaust purification system 70 can be kept by utilizing the heat of radiation from the exhaust manifold 60.

Meanwhile, as shown in FIG. 6, the downstream end of the exhaust purification system 70 is disposed behind the exhaust manifold 60. As described above, such a disposition allows the temperature of a downstream portion (specifically, the vertical side portion 71b of the casing 71) of the exhaust purification system 70 to be kept by utilizing the natural air indicated by the arrows W1 and W2.

Thus, by keeping the temperature of the entirety (from the upstream end to the downstream end) of the exhaust purification system 70, the performance of keeping the temperature of the GPF device 73 is advantageously ensured.

As shown in FIG. 11, the exhaust purification system 70 is disposed so as to coincide with the conduit portion T as viewed from behind the vehicle. As indicated by an arrow W3 shown in FIG. 3, such a layout allows the exhaust purification system 70 to be positioned in the flow path of the natural air, and therefore, the natural air is advantageously blown to the exhaust purification system 70.

In a configuration heretofore typical, the exhaust purification system 70 is contained in the conduit portion T. In this case, even if the engine 1 moves rearward when the front of the vehicle hits something, the exhaust purification system 70 moves in the conduit portion T, and therefore, the contact between the exhaust purification system 70 and the dash panel 103 can be prevented or reduced.

Meanwhile, in this embodiment, the exhaust manifold 60 and the exhaust purification system 70 are closer to each other than in the conventional art so that the temperature of the exhaust purification system 70 is kept by the natural air flowing on or near the exhaust manifold 60. In such a configuration, there may be a risk that, when the front of the vehicle hits something, the exhaust purification system 70 and the dash panel 103 may be brought into contact with each other. In this embodiment, the exhaust purification system 70 and the conduit portion T are arranged to coincide with each other as viewed from behind the vehicle, and therefore, even if the engine 1 moves rearward when the front of the vehicle hits something, the exhaust purification system 70 moves in the conduit portion T.

Thus, safety can be sufficiently ensured in case the front of the vehicle hits something.

As shown in FIG. 8, a combusted gas that has been passed through the GPF device 73 can be used as an external EGR gas. In this case, the flow rate of the gas passing through the GPF device 73 can be increased compared to the configuration in which the EGR passage 52 is coupled upstream of the GPF device 73, for example. Therefore, the temperature of the GPF device 73 is advantageously kept by the gas passing therethrough.

The GPF device 73 functions as a gasoline particulate filter (GPF). Therefore, a gas from which soot has been removed by the GPF can be used as an external EGR gas. This can inhibit or reduce the accumulation of deposits contained in the external EGR gas in the air intake passage 30 coupled to the EGR passage 52.

As described above, natural air is introduced into the engine room R of the automobile 100, flowing from the front to the rear in the vehicle longitudinal direction. At least a portion of the introduced natural air flows from the cylinder head 14 diagonally downward and rearward as indicated by the arrow W1 shown in FIG. 3. The other portion of the natural air flows rearward from the right and left in the vehicle transverse direction of the engine 1, moving around the engine 1.

As shown in FIGS. 8-10, the EGR cooler 53, which can be used as a heat source as described above, is disposed to the left in the vehicle transverse direction, and in front in the vehicle longitudinal direction, of the GPF device 73. Therefore, the natural air that flows from the left in the vehicle transverse direction of the engine 1, moving around the engine 1, receives heat from the EGR cooler 53 before reaching the external surface of the exhaust purification system 70. The resultant natural air can keep the temperature of the GPF device 73 provided in the exhaust purification system 70.

Meanwhile, the merging structure 62 of the exhaust manifold 60 is disposed to the right in the vehicle transverse direction, and in front in the vehicle longitudinal direction, of the GPF device 73. Therefore, the natural air that flows from the right in the vehicle transverse direction of the engine 1, moving around the engine 1, receives heat from the merging structure 62 of the exhaust manifold 60 before reaching the external surface of the exhaust purification system 70. The resultant natural air can keep the temperature of the GPF device 73 provided in the exhaust purification system 70.

Thus, not only the natural air flowing from the cylinder head 14 diagonally downward and rearward, but also the natural air flowing rearward from the right and left in the vehicle transverse direction of the engine 1, moving around the engine 1, are advantageously used to enhance the performance of keeping the temperature of the GPF device 73.

As shown in FIGS. 5-8, the portion of the branch passage 61 corresponding to the section 12 protrudes upward, and therefore, is proportionately separated upward from the two honeycomb catalysts 72a and 72b. Specifically, as shown in FIG. 5, a distance A between the portion of the branch passage 61 corresponding to the section 12 and the exhaust purification system 70 is greater than a distance B between the portion of the branch passage 61 corresponding to the section II and the exhaust purification system 70. Therefore, the portion of the branch passage 61 corresponding to the section 12 is separated upward from the two honeycomb catalysts 72a and 72b, which are located below that portion. As a result, an excessive increase in the temperature of the honeycomb catalysts 72a and 72b can be inhibited or reduced.

Meanwhile, the portion of the branch passage 61 corresponding to the section II protrudes downward, and therefore, proportionately sinks downward and is closer to the cavity portion of the casing 71. As a result, the casing 71 can be heated through the pipes near the cavity portion.

### Other Embodiments

In the above embodiment, an example inline four-cylinder engine has been described. The present disclosure is not limited to this configuration. Alternatively, the present disclosure is applicable to an inline six-cylinder engine. The form of the exhaust manifold 60 may be appropriately changed, depending on the number of cylinders. In the above embodiment, the transverse engine 1 has been described. The present disclosure is not limited to this. Alternatively, the present disclosure is applicable to a longitudinal engine. In this case, an exhaust manifold is disposed to one of the left and right of the engine, and the exhaust purification system 70 is disposed behind the engine as in the transverse engine 1. In this case, if the exhaust manifold and the exhaust purifier are arranged in a relative positional relationship similar to that of the transverse engine, the longitudinal engine also has advantageous effects similar to those of the transverse engine.

What is claimed is:

1. An exhaust system for a vehicle, comprising:
an exhaust passage coupled to a side surface of an engine, wherein
the exhaust passage includes an exhaust manifold and an exhaust purifier disposed serially in a flow direction of an exhaust gas, the exhaust manifold being located upstream of the exhaust purifier,
the exhaust purifier is located below the exhaust manifold, and is disposed so as to overlap the exhaust manifold in a vehicle transverse direction, and
at least a part of the exhaust purifier protrudes with respect to the exhaust manifold rearward in a vehicle longitudinal direction; and
an engine cover configured to cover the engine and provided above the engine to define a gap between the engine cover and the engine in which natural air is allowed to pass, the engine cover having a rear end inclined toward the exhaust manifold.

2. The exhaust system for a vehicle of claim 1, wherein
the exhaust purifier has an upstream end disposed below the exhaust manifold, and a downstream end disposed behind the exhaust manifold.

3. The exhaust system for a vehicle of claim 1, further comprising
a partition wall configured to separate a rear of an engine room in the vehicle longitudinal direction and including a conduit extending from the partition wall rearward in the vehicle longitudinal direction,
wherein
the engine is configured to be mounted in the engine room, and
the exhaust purifier is disposed so as to coincide with the conduit as viewed from in front of or behind the vehicle.

4. The exhaust system for a vehicle of claim 1, wherein
the exhaust purifier includes a purifier contained in the part and configured to purify an exhaust gas, and the purifier is configured to function as a gasoline particulate filter, and
the exhaust system further comprises an EGR passage coupled to the exhaust passage downstream of the purifier and configured to cause at least a portion of a combusted gas to flow back into an air intake passage of the engine.

5. The exhaust system for a vehicle of claim 1, wherein
the exhaust purifier includes a purifier contained in the part and configured to purify an exhaust gas, and
the exhaust manifold has branch passages coupled to respective cylinders of the engine, and a merging structure in which the branch passages merge together, and is coupled to the exhaust purifier, and
the exhaust system further comprises an EGR cooler configured to cool a combusted gas and disposed on one side of the purifier in the vehicle transverse direction and in front of the purifier in the vehicle longitudinal direction, and the merging structure is disposed on another side of the purifier in the vehicle transverse direction and in front of the purifier in the vehicle longitudinal direction.

6. The exhaust system for a vehicle of claim 1, wherein
the part of the exhaust purifier is tube-shaped.
